(19) United States
(12) Patent Application Publication
(10) Pub. No.: US 2022/0219609 A1
(43) Pub. Date: Jul. 14, 2022

(54) VEHICLE MIRROR DEVICE

(71) Applicant: ICHIKOH INDUSTRIES, LTD., Isehara-shi (JP)

(72) Inventors: Yasuo NAGASHIMA, Kanagawa (JP); Takahiro TSUZUKI, Kanagawa (JP); Katsushi OSEKI, Kanagawa (JP); Masataka NAKAGAWA, Kanagawa (JP); Hideto KURIMOTO, Kanagawa (JP)

(73) Assignee: ICHIKOH INDUSTRIES, LTD., Isehara-shi (JP)

(21) Appl. No.: 17/612,460

(22) PCT Filed: Jul. 20, 2020
(86) PCT No.: PCT/IB2020/056791

§ 371 Date: Nov. 18, 2021

(30) Foreign Application Priority Data
May 20, 2019 (JP) 2019-094595
May 20, 2019 (JP) 2019-094596

(51) Int. Cl. B60R 1/074

(52) U.S. Cl. CPC B60R 1/074

(57) ABSTRACT

A vehicle mirror device includes a main body, a drive unit, and a control unit. The main body includes a mirror member and a case member. The mirror member and the case member are provided to be movable integrally with each other. The drive unit is configured to rotate the main body around a first rotation axis and a second rotation axis. The first rotation axis extends along an up-down direction in a vehicle mounted state, and the second rotation axis extends along a left-right direction in the vehicle mounted state. The control unit is configured to control the drive unit such that the main body rotates in a rotation direction and at rotational speed in accordance with a type of a signal from a vehicle.

### FIELD

The present invention relates to a vehicle mirror device.

### BACKGROUND

A known structure of vehicle mirror devices includes a housing accommodating a mirror member, a mirror drive unit driving the mirror member to adjust the rotation position, and a housing drive unit driving the housing to execute retraction and extension (for example, see Patent Literature 1).

### CITATION LIST

### Patent Literature

Patent Literature 1: Japanese Unexamined Patent Application Publication (Translation of PCT Application) No. 2017-537014

### SUMMARY

### Technical Problem

Such vehicle mirror devices are required to have a structure in which a main body is rotatable at speed corresponding to the situation.

The present invention has been made in consideration of the problem described above, and an object of the present invention is to provide a vehicle mirror device capable of rotating a main body at speed corresponding to the situation.

### Solution to Problem

A vehicle mirror device according to the present invention includes: a main body including a mirror member and a case member, the mirror member and the case member being provided to be movable integrally with each other; a drive unit configured to rotate the main body around a first rotation axis and a second rotation axis, the first rotation axis extending along an up-down direction in a vehicle mounted state, the second rotation axis extending along a left-right direction in the vehicle mounted state; and a control unit configured to control the drive unit such that the main body rotates in a rotation direction and at rotational speed in accordance with a type of a signal from a vehicle.

The signal from the vehicle may include a retraction signal to retract the main body, an extension signal to extend the main body, and an adjustment signal to adjust a rotation position of the main body in an extended state. When the signal from the vehicle is the retraction signal or the extension signal, the control unit may set the rotational speed of the main body to be higher than rotational speed set when the signal from the vehicle is the adjustment signal.

When the signal from the vehicle is the retraction signal or the extension signal, the control unit may control the drive unit such that the main body rotates around the first rotation axis.

The drive unit may include a first drive unit configured to rotate the main body around the first rotation axis and a second drive unit configured to rotate the main body around the second rotation axis. The control unit may control the first drive unit when the signal from the vehicle is the retraction signal or the extension signal.

The vehicle mirror device may further include a storage unit configured to store therein a rotation position of the main body. The control unit may control the drive unit on the basis of the rotation position of the main body stored in the storage unit.

The storage unit may store therein the rotation position of the main body in retracting the main body. When retracting the main body, the control unit may control the drive unit such that the main body is disposed in the rotation position of the main body stored in the storage unit.

The storage unit may store therein the rotation position of the main body in extending the main body. When extending the main member unit, the control unit may control the drive unit such that the main body is disposed in the rotation position of the main body stored in the storage unit.

A vehicle mirror device according to the present invention includes: a main body including a mirror member; a drive unit configured to rotate the main body around a first rotation axis and a second rotation axis, the first rotation axis extending along an up-down direction in a vehicle mounted state, and the second rotation axis extending along a left-right direction in the vehicle mounted state; and a control unit configured to control the drive unit such that the main body rotates in a predetermined rotation direction and at predetermined rotational speed in accordance with a signal from a vehicle, the signal from the vehicle being different from an operation signal to operate the main body.

The predetermined rotation speed may be higher than rotational speed set in adjusting a rotation position of the main body in an extended state.

The main body may be provided on each of right and left sides of the vehicle. The signal from the vehicle may include a direction indication signal indicating an indication direction of a direction indicator of the vehicle. When the signal from the vehicle is the direction indication signal, the control unit may control the drive unit such that the main body on a side, of the right and left sides of the vehicle, corresponding to the indication direction indicated with the direction indication signal rotates toward an outside of the vehicle.

The signal from the vehicle may include a shift lever signal indicating a position of a shift lever of the vehicle. When the signal from the vehicle is the shift lever signal, and the shift lever signal indicates that the position of the shift lever is a reverse position, the control unit may control the drive unit such that the main body rotates downward in a vehicle mounted state.

The main body may be provided on each of right and left sides of the vehicle. The signal from the vehicle may include a getting-off signal output when a passenger on a seat on a side opposite to a driver's seat in the left-right direction in the vehicle gets off from the vehicle. When the signal from the vehicle is the getting-off signal, the control unit may control the drive unit such that the main body on the side opposite to the driver's seat in right and left sides in the vehicle rotates toward an outside of the vehicle.

The vehicle mirror device may further include a storage unit configured to store therein a rotation position of the main body. The control unit may control the drive unit on the basis of the rotation position of the main body stored in the storage unit.

### Advantageous Effects of Invention

The present invention provides a vehicle mirror device capable of rotating the main body at speed corresponding to the situation.

### BRIEF DESCRIPTION OF DRAWINGS

FIG. 1 is a plan view illustrating an example of a vehicle including a vehicle mirror device according to an embodiment.

FIG. 2 is a front view of the vehicle mirror device according to the present embodiment.

FIG. 3 is a side view of the vehicle mirror device according to the present embodiment.

FIG. 4 is a diagram illustrating an example of operations of the vehicle mirror device.

FIG. 5 is a diagram illustrating an example of operations of the vehicle mirror device.

FIG. 6 is a diagram illustrating an example of operations of the vehicle mirror device.

FIG. 7 is a diagram illustrating an example of operations of the vehicle mirror device.

FIG. 8 is a plan view illustrating an example of a vehicle including a vehicle mirror device according to an embodiment.

FIG. 9 is a front view of the vehicle mirror device according to the present embodiment.

FIG. 10 is a side view of the vehicle mirror device according to the present embodiment.

FIG. 11 is a diagram illustrating an example of operations of the vehicle mirror device.

FIG. 12 is a diagram illustrating an example of operations of the vehicle mirror device.

FIG. 13 is a diagram illustrating an example of operations of the vehicle mirror device.

FIG. 14 is a diagram illustrating an example of operations of the vehicle mirror device.

FIG. 15 is a diagram illustrating an example of operations of the vehicle mirror device.

FIG. 16 is a diagram illustrating an example of operations of the vehicle mirror device.

FIG. 17 is a diagram illustrating an example of operations of the vehicle mirror device.

FIG. 18 is a diagram illustrating an example of operations of the vehicle mirror device.

FIG. 19 is a diagram illustrating an example of operations of the vehicle mirror device.

FIG. 20 is a diagram illustrating an example of operations of the vehicle mirror device.

### DESCRIPTION OF EMBODIMENTS

An embodiment according to the present invention will be described below with reference to the drawings. The present invention is not limited by the embodiment. Constituent elements in the following embodiments include elements that can be replaced or conceivable by the skilled person, or substantially the same constituent elements.

In the following explanation, the front-rear direction, the up-down direction, and the left-right direction are directions in the vehicle mounted state in which the vehicle mirror device is mounted on the vehicle, and directions when viewing the traveling direction of the vehicle from the driver's seat. In the present embodiment, the up-down direction is parallel with the vertical direction, and the left-right direction is the horizontal direction. In the drawings, viewing from above is referred to as a plan vision and the drawing thereof is referred to as a plan view, and viewing from the rear is referred to as a front vision and the drawing thereof is referred to as a front view.

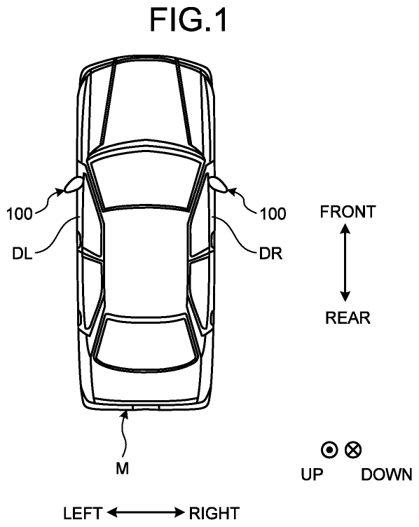

FIG. 1 is a plan view illustrating an example of a vehicle M including a vehicle mirror device 100 according to the present embodiment. As illustrated in FIG. 1, the vehicle mirror device 100 is what is called a door mirror, and attached to each of outer sides of the vehicle M, that is, each of left and right doors DL and DR of the vehicle M. The right and left vehicle mirror devices 100 are substantially symmetrical in the left-right direction.

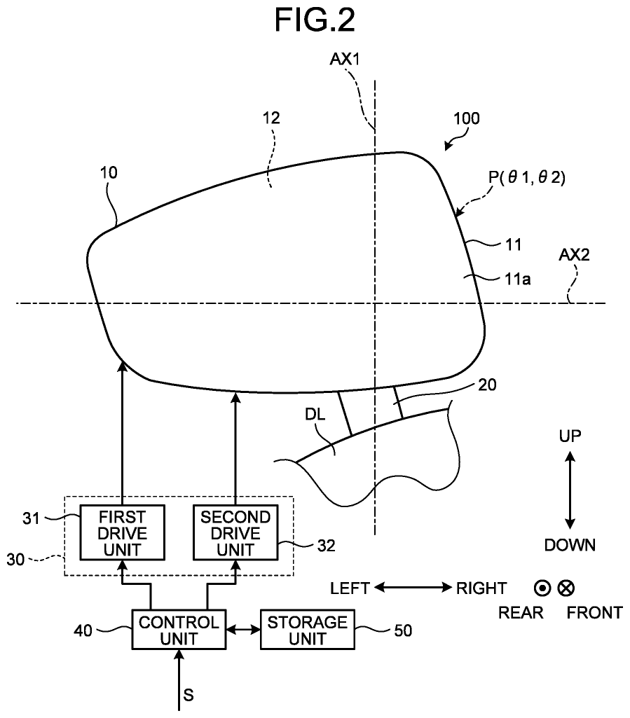

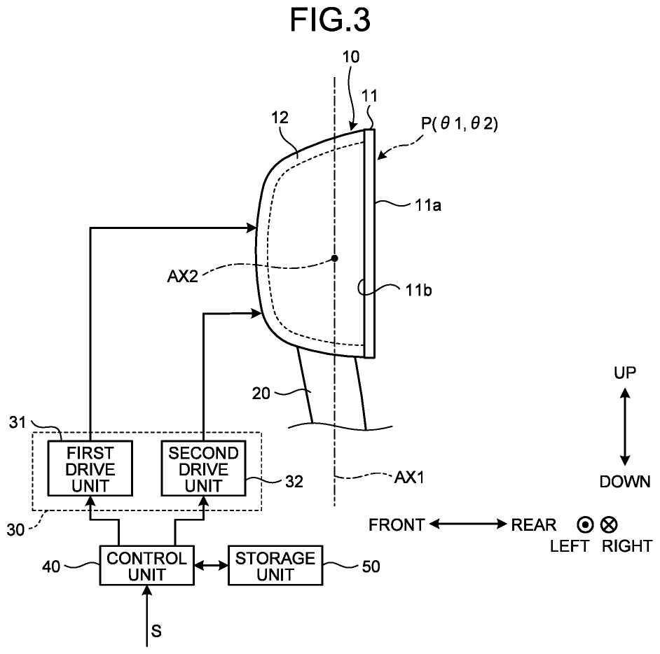

FIG. 2 is a front view of the vehicle mirror device 100 according to the present embodiment. FIG. 3 is a side view of the vehicle mirror device 100 according to the present embodiment. FIG. 2 and FIG. 3 illustrate the vehicle mirror device 100 configured as a door mirror. FIG. 2 and FIG. 3 illustrate a door mirror on the left side of the vehicle M illustrated in FIG. 1.

The vehicle mirror device 100 includes a main body 10, a vehicle connection part 20, a drive unit 30, and a control unit 40. The main body 10 includes a mirror member 11 and a case member 12. The mirror member 11 is formed in a plate shape using, for example, glass or resin. The mirror member 11 includes a reflection surface 11a on an end surface on the rear side in the vehicle mounted state. The case member 12 is provided to cover a surface 11b opposite to the reflection surface 11a in the mirror member 11. The case member 12 is provided integrally with the mirror member 11. The case member 12 is hollow and forms a space capable of containing other components between the case member 12 and the mirror member 11.

In the vehicle mirror device 100 according to the present embodiment, the main body 10 is in a state in which the whole main body 10 is exposed to the outside. Specifically, the vehicle mirror device 100 has a structure provided with no housing surrounding the front and the rear, the right and the left, and the ahead of the main body 10. In this structure, substantially the whole surface of the outer shape portion of the main body 10 in front view is the reflection surface 11a, as illustrated in FIG. 2. For this reason, this structure secures a sufficiently wide reflection surface 11a even when the main body 10 is miniaturized. In addition, providing no housing achieves a structure in which the housing is not reflected on the reflection surface 11a as viewed from the driver's seat, even when the main body 10 is largely rotated in the up-down direction and the left-right direction.

In the main body 10, the mirror member 11 and the case member 12 are provided to be movable integrally with each other. In this structure, the whole main body 10 exposed to the outside moves with respect to the vehicle connection part 20, and thereby retracted in a certain retracted state, extended in a certain extended state, and adjusted to a predetermined rotation position in the extended state. Specifically, in this structure, the main body 10 is directly rotated both in executing retraction and extension and in adjusting the rotation position in the extended state.

The vehicle connection part 20 connects the main body 10 to the vehicle M. The vehicle connection part 20 is connected to the case member 12 of the main body 10 to support the main body 10. The main body 10 is movable in the state of being supported with the vehicle connection part 20.

The drive unit 30 rotates the main body 10 around a first rotation axis AX1 and a second rotation axis AX2. The first rotation axis AX1 is an axis extending along the up-down direction. The second rotation axis AX2 is an axis extending along the left-right direction. The drive unit 30 includes a first drive unit 31 that rotates the main body 10 around the first rotation axis AX1, and a second drive unit 32 that rotates the main body 10 around the second rotation axis AX2. Each of the first drive unit 31 and the second drive unit 32 includes a drive source, such as a motor, and a transmission mechanism, such as gears. The first drive unit 31 and the second drive unit 32 are illustrated with blocks in FIG. 1 and FIG. 2. The first drive unit 31 and the second drive unit 32 may be arranged in, for example, a space formed with the mirror member 11 and the case member 12 of the main body 10.

The drive unit 30 is capable of disposing the main body 10 in a desired rotation position P by rotating the main body 10. In the present embodiment, the rotation position P can be expressed with a rotation angle 81 in the rotation direction around the first rotation axis AX1 and the rotation angle 82 in the rotation direction around the second rotation axis AX2 with respect to a reference position, for example, in the case of setting the certain reference position. A rotation position P may be expressed by another method.

The control unit 40 includes a microprocessor, such as a central processing unit (CPU), a memory, such as a read-only memory (ROM) and a random-access memory (RAM), and a storage.

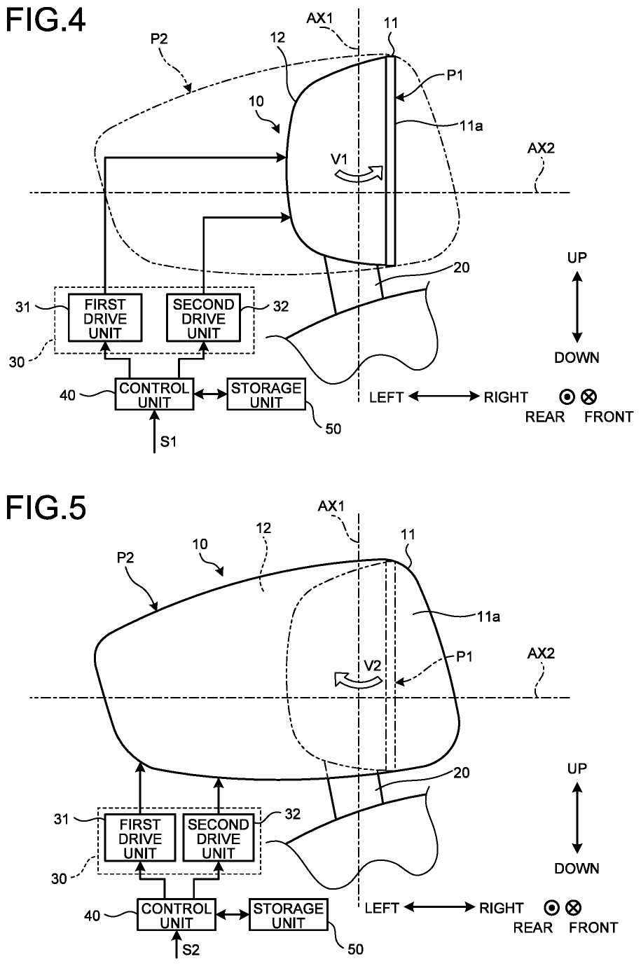

In the present embodiment, the control unit 40 controls the drive unit 30 such that the main body 10 rotates in a rotation direction and at rotational speed in accordance with a signal S from the vehicle. Examples of the signal S from the vehicle include a retraction signal S1 (see FIG. 4) to retract the main body 10, an extension signal S2 (see FIG. 5) to extend the main body 10, and an adjustment signal to adjust the rotation position of the main body 10 in the extended state.

The retraction signal S1 and the extension signal S2 are output from the vehicle in response to, for example, operation of a retraction switch or an extension switch provided in the vehicle. Each of the retraction signal S1 and the extension signal S2 is output by executing an operation of executing a retracting operation or an extension operation with the retraction switch or the extension switch once.

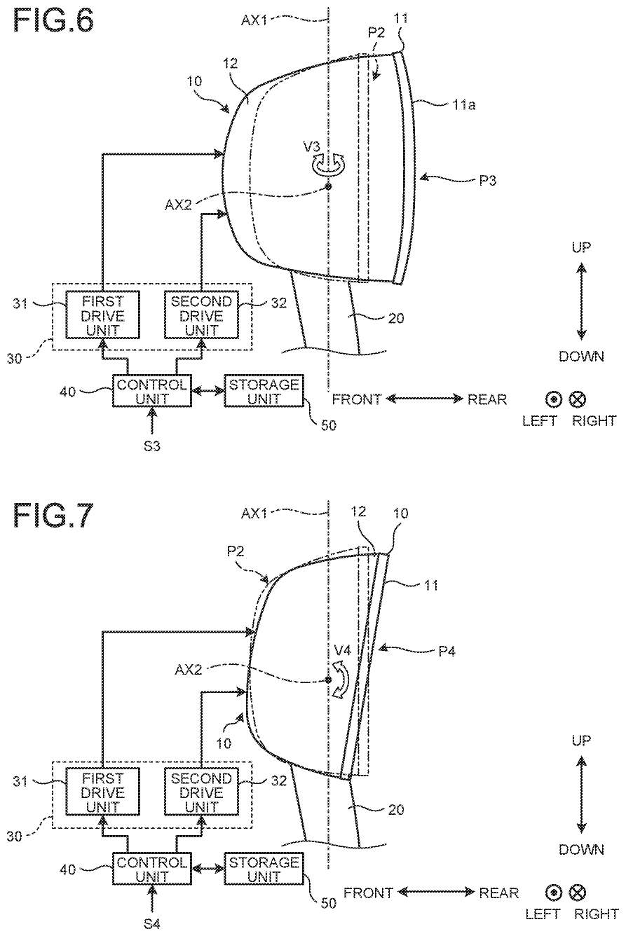

The adjustment signal includes a right-left adjustment signal S3 (see FIG. 6) to adjust the rotation position in the left-right direction in the vehicle mounted state and an up-down adjustment signal S4 (see FIG. 7) to adjust the rotation position in the up-down direction in the vehicle mounted state. The right-left adjustment signal S3 and the up-down adjustment signal S4 are output from the vehicle in response to, for example, operation of a rotation position adjustment switch provided on the vehicle. Each of the adjustment signals S3 and S4 includes information relating to the rotation direction and the rotational speed. In the right-left adjustment signal S3, the information relating to the rotation direction is a rotation direction (either left or right) around the first rotation axis AX1. In the up-down adjustment signal S4, and the information relating to the rotation direction the up-down adjustment signal S4 is a rotation direction (either up or down) around the second rotation axis AX2. The rotation amount is set on the basis of, for example, the length of the time for which the rotation position adjustment switch is operated. In this case, the rotation amount can be set such that the longer in time the rotation position adjustment switch is operated, the larger the rotation amount; and the shorter in time the rotation position adjustment switch is operated, the smaller the rotation amount.

When the signal S from the vehicle is the retraction signal S1 or the extension signal S2, the control unit 40 sets the rotational speed of the main body 10 to be higher than the rotational speed set when the signal from the vehicle is the adjustment signal S3 or S4. Such setting enables execution of retraction and extension of the main body 10 in a shorter time. In addition, when adjusting the rotation position of the main body 10, such setting enables adjustment at rotational speed not too high for the driver or the like who executes adjustment.

When the signal S from the vehicle is the retraction signal S1 or the extension signal S2, the control unit 40 controls the drive unit 30 such that the main body 10 rotates around the first rotation axis AX1. This control is referred to as a “first retraction/extension mode” hereinafter. Executing the first retraction/extension mode enables prompt retraction and extension of the main body 10.

When the signal S from the vehicle is the retraction signal S1 or the extension signal S2, the control unit 40 may control the drive unit 30 such that the main body 10 rotates around the first rotation axis AX1 and the second rotation axis AX2. This control is referred to as a “second retraction/extension mode” hereinafter. Executing the second retraction/extension mode enables adjustment of the rotation position of the main body 10 for the rotation direction around the second rotation axis AX2.

In addition, when the signal S from the vehicle is the adjustment signal S3 or S4, the control unit 40 controls the drive unit 30 such that the main body 10 is rotated around the first rotation axis AX1 and the second rotation axis AX2 in accordance with the adjustment details. This control enables adjustment of the reflection surface 11a to a desired rotation position.

A storage unit 50 stores therein the rotation position of the main body 10. The storage unit 50 is capable of storing therein, for example, the retracted position serving as the rotation position of the main body 10 in retracting the main body 10, and the extended position serving as the rotation position of the main body 10 in extending the main body 10, and the like.

The control unit 40 described above controls the drive unit 30 on the basis of the rotation position of the main body 10 stored in the storage unit 50. When the main body 10 is retracted, the control unit 40 controls the drive unit 30 such that the main body 10 is disposed in a retracted position P1 stored in the storage unit 50. When the main body 10 is extended, the control unit 40 controls the drive unit 30 such that the main body 10 is disposed in an extended position P2 stored in the storage unit 50.

For example, when the control unit 40 executes the first retraction/extension mode, only the rotation angle θ1 around the first rotation axis AX1 is set for the retracted position P1 and the extended position P2, and the rotation angle θ2 around the second rotation axis AX2 is not set for them. When the control unit 40 executes the second retraction/extension mode, both the rotation angle θ1 around the first rotation axis AX1 and the rotation angle θ2 around the second rotation axis AX2 are set for the retracted position P1 and the extended position P2.

The following is an explanation of operations of the vehicle mirror device 100 configured as described above. FIG. 4 to FIG. 7 are diagrams illustrating an example of operations of the vehicle mirror device 100.

As illustrated in FIG. 4, when the retraction signal S1 is transmitted from the vehicle in the state in which the main body 10 is disposed in the extended position P2, the control unit 40 controls the drive unit 30 such that the main body 10 is retracted. In this case, the control unit 40 controls the drive unit 30, for example, on the basis on information of the retracted position P1 stored in the storage unit 50. Specifically, the control unit 40 controls the drive unit 30 such that the main body 10 is disposed in the retracted position P1. In the first retraction/extension mode, the control unit 40 controls the drive unit 30 such that the main body 10 rotates around the first rotation axis AX1. In the second retraction/extension mode, the control unit 40 controls the drive unit 30 such that the main body 10 rotates around the first rotation axis AX1 and the second rotation axis AX2. In the second retraction/extension mode, when a difference in rotation position between the extended position P2 and the retracted position P1 is 0 for the rotation direction around the second rotation axis AX2, the main body 10 is not required to rotate in the rotation direction around the second rotation axis AX2. When the main body 10 is retracted, the control unit 40 controls the drive unit 30 such that the rotational speed is controlled to first speed V1. With this control, the main body 10 is disposed in the retracted position P1 from the extended position P2.

As illustrated in FIG. 5, when the extension signal S2 is transmitted from the vehicle in the state in which the main body 10 is disposed in the retracted position P1, the control unit 40 controls the drive unit 30 such that the main body 10 is extended. In this case, the control unit 40 controls the drive unit 30, for example, on the basis of information on the extended position P2 stored in the storage unit 50. Specifically, the control unit 40 controls the drive unit 30 such that the main body 10 is disposed in the extended position P2. In the first retraction/extension mode, the control unit 40 controls the drive unit 30 such that the main body 10 rotates around the first rotation axis AX1. In the second retraction/extension mode, the control unit 40 controls the drive unit 30 such that the main body 10 rotates around the first rotation axis AX1 and the second rotation axis AX2. In the second retraction/extension mode, when a difference in rotation position between the retracted position P1 and the extended position P2 is 0 for the rotation direction around the second rotation axis AX2, the main body 10 is not required to rotate in the rotation direction around the second rotation axis AX2. When the main body 10 is extended, the control unit 40 controls the drive unit 30 such that the rotational speed is controlled to second speed V2. With this control, the main body 10 is disposed in the extended position P2 from the retracted position P1.

As illustrated in FIG. 6, when the right-left adjustment signal S3 is transmitted from the vehicle in the state in which the main body 10 is disposed in the extended position P2, the control unit 40 controls the drive unit 30 such that the main body 10 rotates on the basis of information on the rotation direction and the rotation amount included in the right-left adjustment signal S3. Specifically, the control unit 40 adjusts the rotation position of the main body 10 in the left-right direction by rotating the main body 10 by a predetermined rotation amount in the rotation direction (either left or right) around the first rotation axis AX1. When adjusting the rotation position of the main body 10 in the left-right direction, the control unit 40 controls the drive unit 30 such that the rotational speed is controlled to third speed V3. With this control, the main body 10 is disposed in an adjustment position P3 acquired by rotating the main body 10 leftward or rightward by a predetermined rotation amount from the extended position P2.

As illustrated in FIG. 7, when the up-down adjustment signal S4 is transmitted from the vehicle in the state in which the main body 10 is disposed in the extended position P2, the control unit 40 controls the drive unit 30 such that the main body 10 rotates on the basis of information on the rotation direction and the rotation amount included in the up-down adjustment signal S4. Specifically, the control unit 40 adjusts the rotation position of the main body 10 in the up-down direction by rotating the main body 10 by a predetermined rotation amount in the rotation direction (either up or down) around the second rotation axis AX2. When adjusting the rotation position of the main body 10 in the up-down direction, the control unit 40 controls the drive unit 30 such that the rotational speed is controlled to fourth speed V4. With this control, the main body 10 is disposed in an adjustment position P4 acquired by rotating the main body 10 upward or downward by a predetermined rotation amount from the extended position P2.

When executing the operations illustrated in FIG. 4 to FIG. 7, the control unit 40 controls the drive unit 30 such that the first speed V1 in retracting the main body 10 and the second speed V2 in extending the main body 10 are higher than the third speed V3 in adjusting the rotation position of the main body 10 in the left-right direction and the fourth speed V4 in adjusting the rotation position of the main body 10 in the up-down direction. When the main body 10 is retracted or extended, the rotation amount is larger than that in adjustment of the rotation position of the main body 10. For this reason, the first speed V1 and the second speed V2 in retracting and extending the main body 10 are set higher than the third speed V3 and the fourth speed V4 in adjusting the rotation position. This setting shortens the driver's waiting time. In addition, in adjusting the rotation position of the main body 10, this setting enables adjustment at the rotational speed that is not too fast for the driver or the like performing adjustment.

As described above, the vehicle mirror device 100 according to the present embodiment includes: the main member part 10 including the mirror member 11 and the case member 12 and in which the mirror member 11 and the case member 12 are provided to be movable integrally with each other; the drive unit 30 that rotates the main body 10 around the first rotation axis AX1 extending along the up-down direction in the vehicle mounted state and the second rotation axis AX2 extending along the left-right direction in the vehicle mounted state; and the control unit 40 that controls the drive unit 30 such that the main body 10 rotates in the rotation direction and at the rotational speed in accordance with the type of the signal S from the vehicle.

Because the main body 10 is movable in the state in which the whole main body 10 is exposed to the outside, this structure enables miniaturization in comparison with the structure in which the main body 10 is contained in a housing or the like. In addition, this structure enables rotation of the main body 10 at speed in accordance with the situation, by rotating the main body 10 in the rotation direction and at the rotational speed in accordance with the type of the signal S from the vehicle.

In the vehicle mirror device 100 according to the present embodiment, the signal S from the vehicle includes the retraction signal S1 to retract the main body 10, the extension signal S2 to extend the main body 10, and the adjustment signals S3 and S4 to adjust the rotation position of the main body 10 in the extended state. When the signal from the vehicle is the retraction signal S1 or the extension signal S2, the control unit 40 sets the rotational speed of the main body 10 to be higher than the rotational speed set when the signal from the vehicle is the adjustment signal S3 or S4. This setting enables retraction and extension of the main body 10 in a shorter time. In addition, when adjusting the rotation position of the main body 10, the setting enables adjustment at rotational speed that is not too fast for the driver or the like performing adjustment.

In the vehicle mirror device 100 according to the present embodiment, when the signal S from the vehicle is the retraction signal S1 or the extension signal S2, the control unit 40 controls the drive unit 30 such that the main body 10 rotates around the first rotation axis AX. This control enables prompt retraction and extension of the main body 10.

In the vehicle mirror device 100 according to the present embodiment, the drive unit 30 includes the first drive unit 31 rotating the main body 10 around the first rotation axis AX1, and the second drive unit 32 rotating the main body 10 around the second rotation axis AX2, and the control unit 40 controls the first drive unit 31 when the signal S from the vehicle is the retraction signal S1 or the extension signal S2. Efficiency of control of retraction and extension can be improved by adopting the structure of using the first drive unit 31 when the main body 10 is retracted or extended.

The vehicle mirror device 100 according to the present embodiment further includes the storage unit 50 storing therein the rotation position of the main body 10, and the control unit 40 controls the drive unit 30 on the basis of the rotation position of the main body 10 stored in the storage unit 50. This structure enables easy control of retraction and extension on the basis of the rotation position stored in the storage unit 50.

In addition, the storage unit 50 stores therein the retracted position P1 serving as the rotation position of the main body 10 in retracting the main body 10, and when retracting the main body 10, the control unit 40 controls the drive unit 30 such that the main body 10 is disposed in the retracted position P1 stored in the storage unit 50. This structure enables easy control in retraction on the basis of the retracted position P1 stored in the storage unit 50.

In addition, the storage unit 50 stores therein the rotation position of the main body 10 in extending the main body 10, and when extending the main body 10, the control unit 40 controls the drive unit 30 such that the main body 10 is disposed in the rotation position of the main body 10 stored in the storage unit 50. This structure enables easy control in extension on the basis of the extended position P2 stored in the storage unit 50.

Next, another embodiment according to the present invention will be described on the basis of the drawings. The present invention is not limited by the embodiment. Constituent elements in the following embodiment include elements that can be replaced and conceivable by the skilled person, or substantially the same constituent elements.

In the following explanation, the front-rear direction, the up-down direction, and the left-right direction are directions in the vehicle mounted state in which the vehicle mirror device is mounted on the vehicle, and directions when viewing the traveling direction of the vehicle from the driver's seat. In the present embodiment, the up-down direction is parallel with the vertical direction, and the left-right direction is the horizontal direction. In the drawings, viewing from above is referred to as a plan vision and the drawing thereof is referred to as a plan view, and viewing from the rear is referred to as a front vision and the drawing thereof is referred to as a front view.

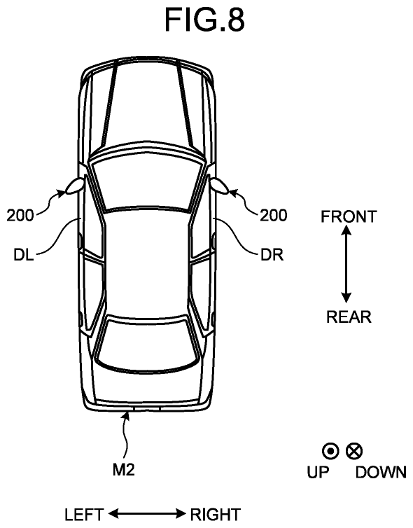

FIG. 8 is a plan view illustrating an example of a vehicle M2 including a vehicle mirror device 200 according to the present embodiment. As illustrated in FIG. 8, the vehicle mirror device 200 is what is called a door mirror, and attached to each of outer sides of the vehicle M2, that is, each of left and right doors DL and DR of the vehicle M2. The right and left vehicle mirror devices 200 are substantially symmetrical in the left-right direction.

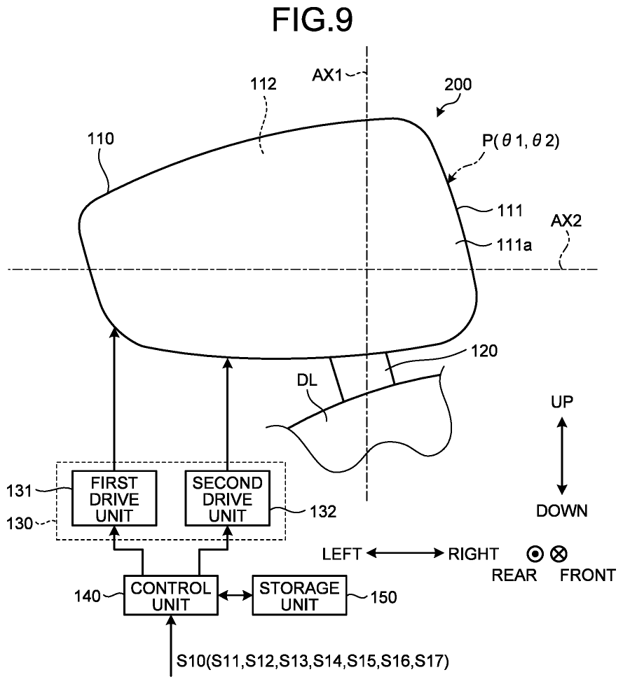

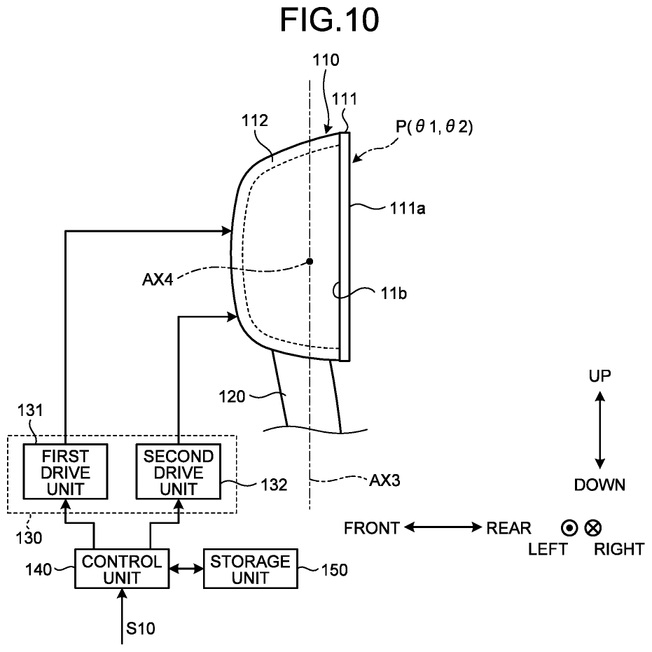

FIG. 9 is a front view of the vehicle mirror device 200 according to the present embodiment. FIG. 10 is a side view of the vehicle mirror device 200 according to the present embodiment. FIG. 9 and FIG. 10 illustrate the vehicle mirror device 200 configured as a door mirror. FIG. 9 and FIG. 10 illustrate a door mirror on the left side of the vehicle M2 illustrated in FIG. 8.

The vehicle mirror device 200 includes a main body 110, a vehicle connection part 120, a drive unit 130, and a control unit 140. The main body 110 includes a mirror member 111 and a case member 112. The mirror member 111 is formed in a plate shape using, for example, glass or resin. The mirror member 111 includes a reflection surface 111a on an end surface on the rear side in the vehicle mounted state. The case member 112 is provided to cover a surface 111b opposite to the reflection surface 111a in the mirror member 111. The case member 112 is provided integrally with the mirror member 111. The case member 112 is hollow and forms a space capable of containing other components between the case member 112 and the mirror member 111.

In the vehicle mirror device 200 according to the present embodiment, the main body 110 is in a state in which the whole main body 110 is exposed to the outside. Specifically, the vehicle mirror device 200 has a structure provided with no housing surrounding the front and the rear, the right and the left, and the ahead of the main body 110. In this structure, substantially the whole surface of the outer shape portion of the main body 110 in front view is the reflection surface 111a, as illustrated in FIG. 9. For this reason, this structure secures a sufficiently wide reflection surface 111a even when the main body 110 is miniaturized. In addition, providing no housing achieves a structure in which the housing is not reflected on the reflection surface 111a as viewed from the driver's seat, even when the main body 110 is largely rotated in the up-down direction and the left-right direction.

In the main body 110, the mirror member 111 and the case member 112 are provided to be movable integrally with each other. In this structure, the whole main body 110 in the state of being exposed to the outside moves with respect to the vehicle connection part 120, and thereby retracted in a certain retracted state, extended in a certain extended state, and adjusted to a predetermined rotation position in the extended state. Specifically, in this structure, the main body 110 is directly rotated both in executing retraction and extension and in adjusting the rotation position in the extended state.

The vehicle connection part 120 connects the main body 110 to the vehicle M2. The vehicle connection part 120 is connected to the case member 112 of the main body 110 to support the main body 110. The main body 110 is movable in the state of being supported with the vehicle connection part 120.

The drive unit 130 rotates the main body 110 around a first rotation axis AX1 and a second rotation axis AX2. The first rotation axis AX1 is an axis extending along the up-down direction. The second rotation axis AX2 is an axis extending along the left-right direction. The drive unit 130 includes a first drive unit 131 that rotates the main body 110 around the first rotation axis AX1 and a second drive unit 132 rotating the main body 110 around the second rotation axis AX2. Each of the first drive unit 131 and the second drive unit 132 includes a drive source, such as a motor, and a transmission mechanism, such as gears. The first drive unit 131 and the second drive unit 132 are illustrated with blocks in FIG. 8 and FIG. 9, but may be arranged in, for example, a space formed with the mirror member 111 and the case member 112 of the main body 110.

The drive unit 130 is capable of disposing the main body 110 in a desired rotation position P by rotating the main body 110. In the present embodiment, the rotation position P can be expressed with a rotation angle 81 in the rotation direction around the first rotation axis AX1 and the rotation angle 82 in the rotation direction around the second rotation axis AX2 with respect to a reference position, for example, in the case of setting the certain reference position. A rotation position P may be expressed by another method.

The control unit 140 includes a microprocessor, such as a central processing unit (CPU), a memory, such as a read-only memory (ROM) and a random-access memory (RAM), and a storage.

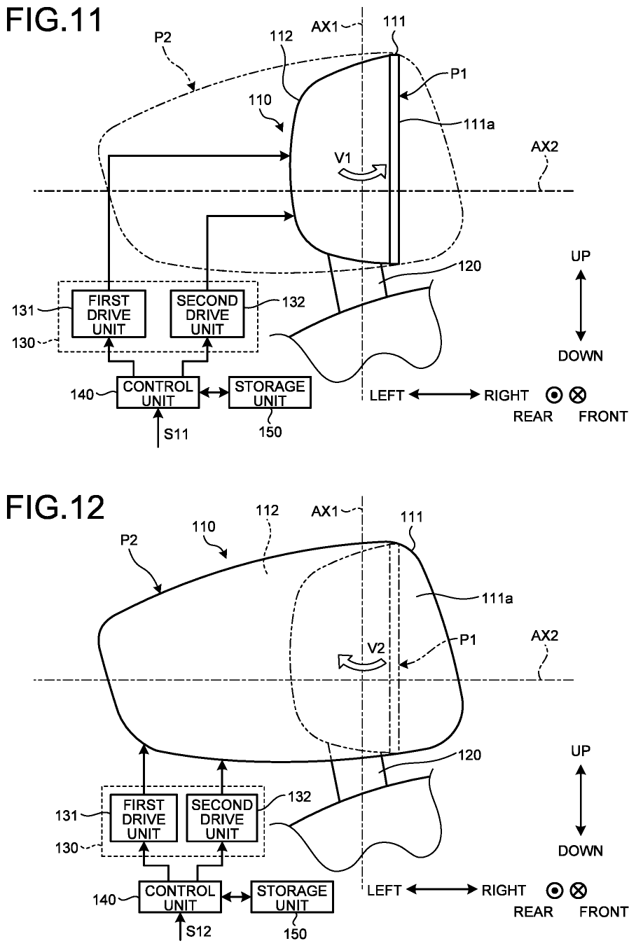

In the present embodiment, the control unit 140 controls the drive unit 130 such that the main body 110 rotates in the rotation direction and at the rotational speed in accordance with a signal S10 from the vehicle. Examples of the signal S10 from the vehicle include a retraction signal S11 (see FIG. 11) to retract the main body 110, an extension signal S12 (see FIG. 12) to extend the main body 110, an adjustment signal to adjust the rotation position of the main body 110 in the extended state, and other signals.

The retraction signal S11 and the extension signal S12 are operation signals to operate the main body 110, and output from the vehicle in response to, for example, operation of a retraction switch or an extension switch provided on the vehicle. Each of the retraction signal S11 and the extension signal S12 is output by executing an operation of executing a retracting operation or an extension operation with the retraction switch or the extension switch once.

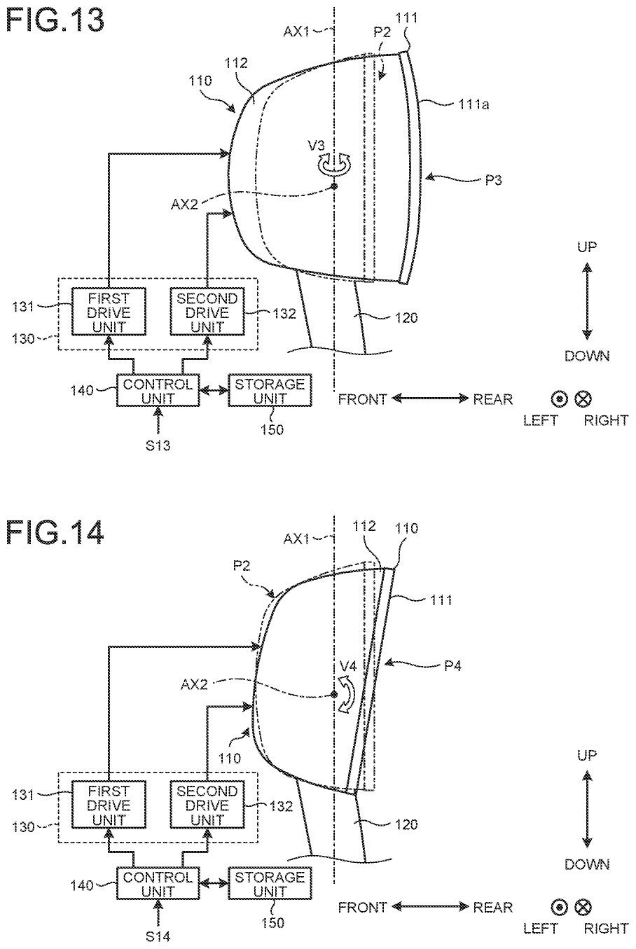

The adjustment signal includes a right-left adjustment signal S13 (see FIG. 13) to adjust the rotation position in the left-right direction in the vehicle mounted state and an up-down adjustment signal S14 (see FIG. 14) to adjust the rotation position in the up-down direction in the vehicle mounted state. The right-left adjustment signal S13 and the up-down adjustment signal S14 are output from the vehicle in response to, for example, operation of a rotation position adjustment switch provided on the vehicle. Each of the adjustment signals S13 and S14 includes information relating to the rotation direction and the rotational speed. In the right-left adjustment signal S13, the information relating to the rotation direction is a rotation direction (either left or right) around the first rotation axis AX1. In the up-down adjustment signal S14, the information relating to the rotation direction is a rotation direction (either up or down) around the second rotation axis AX2. The rotation amount is set on the basis of, for example, the length of the time for which the rotation position adjustment switch is operated. In this case, the rotation amount can be set such that the longer in time the rotation position adjustment switch is operated, the larger the rotation amount; and the shorter in time the rotation position adjustment switch is operated, the smaller the rotation amount.

The signal S10 from the vehicle also includes signals different from the operation signals described above. For example, the signal S10 from the vehicle includes a direction indication signal S15, a shift lever signal S16, and a getting-off signal S17. The direction indication signal S15 is a signal output when a direction indicator (not illustrated) provided on the vehicle M2 is operated. The direction indication signal S15 includes information relating to the indication direction (either left or right direction) indicated with the direction indicator.

The shift lever signal S16 is a signal output when a shift lever (not illustrated) provided on the vehicle M2 is operated. The shift lever signal S16 includes information indicating the position of the shift lever. The shift lever is switchable to, for example, a forward position, a reverse position, a parking position, and a neutral position.

The getting-off signal S17 is a signal output when the passenger on the seat on the opposite side of the driver's seat in the left-right direction in the vehicle M2 gets off from the vehicle. The getting-off signal S17 includes, for example, at least one of an engine stop signal output when the engine of the vehicle M2 stops, an unlock signal output when the door of the vehicle M2 is unlocked, a belt release signal output when the seatbelt is released, a parking signal output when the shift lever is switched to the parking position, and an passenger detection signal detecting that an passenger is seated on the passenger seat. Two or more of these signals may be used in combination, as the getting-off signal S17.

The control unit 140 controls the rotation position of the main body 110 on the basis of the operation signal (retraction signal S11, extension signal S12, and adjustment signals S13 and S14). When the signal S10 from the vehicle is the retraction signal S11 or the extension signal S12, the control unit 140 sets the rotational speed of the main body 110 to be higher than the rotational speed set when the signal from the vehicle is the adjustment signal S13 or S14. Such setting enables execution of retraction and extension of the main body 110 in a shorter time. In addition, when adjusting the rotation position of the main body 110, such setting enables adjustment at rotational speed not too high for the driver or the like who executes adjustment.

When the signal S10 from the vehicle is the retraction signal S11 or the extension signal S12, the control unit 140 controls the drive unit 130 such that the main body 110 is rotated around the first rotation axis AX1. This control is referred to as a “first retraction/extension mode” hereinafter. Executing the first retraction/extension mode enables prompt retraction and extension of the main body 110.

When the signal S10 from the vehicle is the retraction signal S11 or the extension signal S12, the control unit 140 may control the drive unit 130 such that the main body 110 rotates around the first rotation axis AX1 and the second rotation axis AX2. This control is referred to as a “second retraction/extension mode” hereinafter. Executing the second retraction/extension mode enables adjustment of the rotation position of the main body 110 for the rotation direction around the second rotation axis AX2.

In addition, when the signal S10 from the vehicle is the adjustment signal S13 or S14, the control unit 140 controls the drive unit 130 such that the main body 110 is rotated around the first rotation axis AX1 and the second rotation axis AX2 in accordance with the adjustment details. This control enables adjustment of the reflection surface 111a to a desired rotation position.

In addition, when the signal S10 from the vehicle is, for example, the direction indication signal S15, the shift lever S16, or the getting-off signal S17 described above, the control unit 140 controls the drive unit 130 such that the main body 110 rotates in a predetermined rotation direction and at predetermined rotational speed in accordance with the signal S10 from the vehicle, as described hereinafter. The control unit 140 is capable of setting the predetermined rotational speed to rotational speed higher than the rotational speed set in retracting or extending the main body 110.

When the signal S10 from the vehicle is the direction indication signal S15, the control unit 140 controls the drive unit 130 such that the main body 110 on the side, of the right and left of the vehicle M2, corresponding to the indication direction indicated with the direction indirection signal S15 rotates toward the outside of the vehicle M2. Specifically, when the indication direction from the direction indicator is the left direction, the control unit 140 controls the drive unit 130 such that the main body 110 of the vehicle mirror device 200 disposed on the left side of the vehicle M2 rotates toward the outside of the vehicle M2. When the indication direction from the direction indicator is the right direction, the control unit 140 controls the drive unit 130 such that the main body 110 of the vehicle mirror device 200 disposed on the right side of the vehicle M2 rotates toward the outside of the vehicle M2. This control is referred to as “indicator rotation mode” hereinafter.

When the signal S10 from the vehicle is the shift lever signal S16, and the position indicated with the shift lever signal S16 is the reverse position, the control unit 140 controls the drive unit 130 such that the main body 110 rotates downward in the vehicle mounted state. The control unit 140 may control the drive unit 130 to rotate the main body 110 provided on one of the right and left vehicle mirror devices 200 of the vehicle M2, or may control the drive unit 130 to rotate both the main body 110 of the right and left vehicle mirror devices 200 of the vehicle M2. For example, the control unit 140 may control the drive unit 130 such that the main body 110 of the vehicle mirror device 200 disposed on the side opposite to the driver's seat in the left-right direction of the vehicle M2, that is, disposed on the passenger seat side, rotates downward. This control is referred to as “shift rotation mode” hereinafter.

When the signal S10 from the vehicle is the getting-off signal S17, the control unit 140 may control the drive unit 130 such that the main body 110 on the side opposite to the driver's seat in the left-right direction of the vehicle M2, that is, on the passenger seat side, rotates toward the outside of the vehicle M2. Specifically, when the driver's seat is located on the right side in the vehicle M2, the control unit 140 controls the drive unit 130 such that the main body 110 of the vehicle mirror device 200 disposed on the left side of the vehicle M2 rotates toward the outside of the vehicle M2. In addition, when the driver's seat is located on the left side in the vehicle M2, the control unit 140 controls the drive unit 130 such that the main body 110 of the vehicle mirror device 200 disposed on the right side of the vehicle M2 rotates toward the outside of the vehicle M2. This control is referred to as “stop/release rotation mode” hereinafter.

The storage unit 150 stores therein the rotation position of the main body 110. The storage unit 150 is capable of storing therein, for example, the retracted position serving as the rotation position of the main body 110 in retracting the main body 110, the extended position serving as the rotation position of the main body 110 in extending the main body 110, an indicator operation position serving as the rotation position at the time when the main body 110 is rotated in the indicator rotation mode, a reverse position serving as the rotation position at the time when the main body 110 is rotated in the shift rotation mode, and a stop/release position serving as the rotation position at the time when the main body 110 is rotated in the stop/release rotation mode, and the like.

The control unit 140 described above controls the drive unit 130 on the basis of the rotation position of the main body 110 stored in the storage unit 150. When the main body 110 is retracted, the control unit 140 controls the drive unit 130 such that the main body 110 is disposed in the retracted position P1 stored in the storage unit 150. When the main body 110 is extended, the control unit 140 controls the drive unit 130 such that the main body 110 is disposed in the extended position P2 stored in the storage unit 150.

For example, when the control unit 140 executes the first retraction/extension mode, only the rotation angle 81 around the first rotation axis AX1 is set for the retracted position P1 and the extended position P2, and the rotation angle 82 around the second rotation axis AX2 is not set for them. When the control unit 140 executes the second retraction/extension mode, both the rotation angle 81 around the first rotation axis AX1 and the rotation angle 82 around the second rotation axis AX2 are set for the retracted position P1 and the extended position P2.

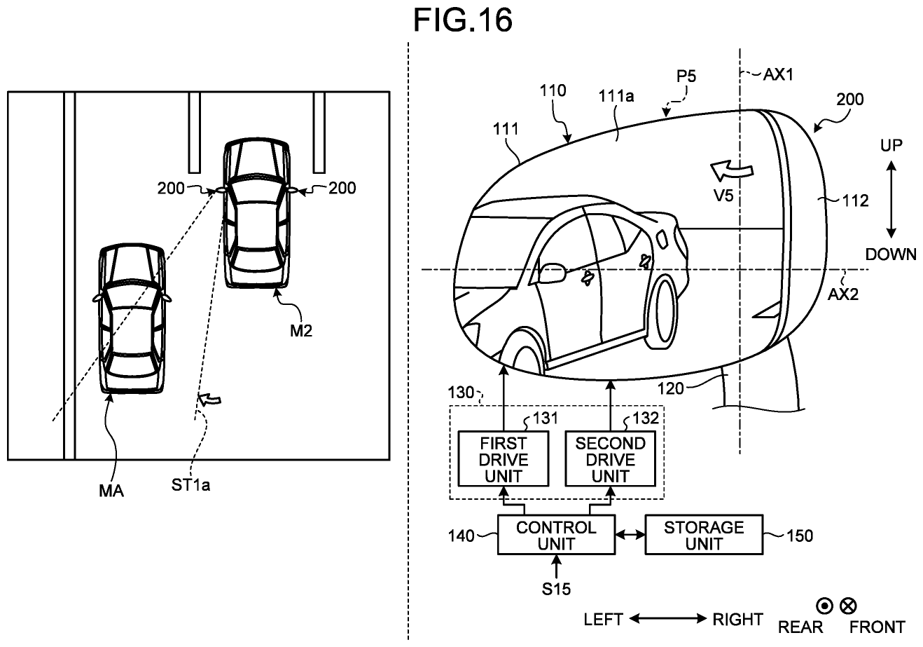

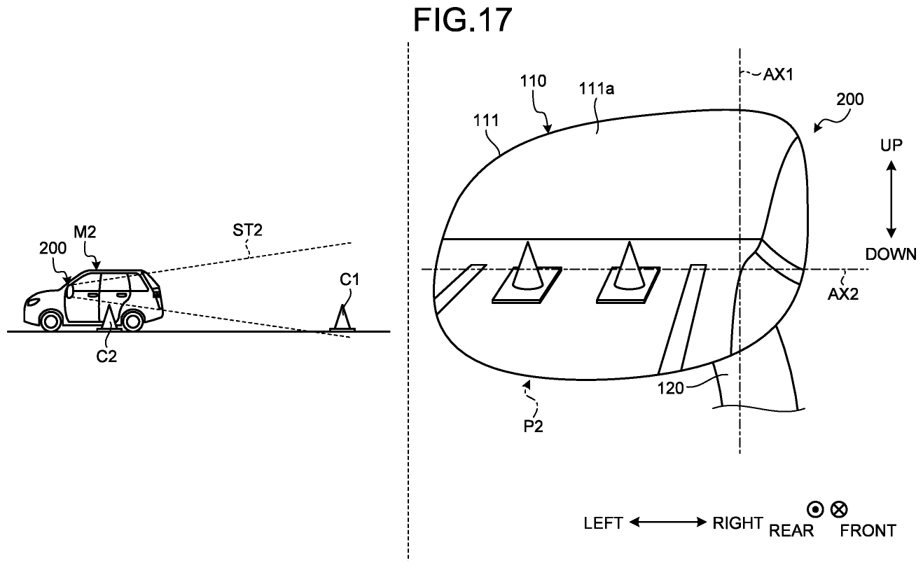

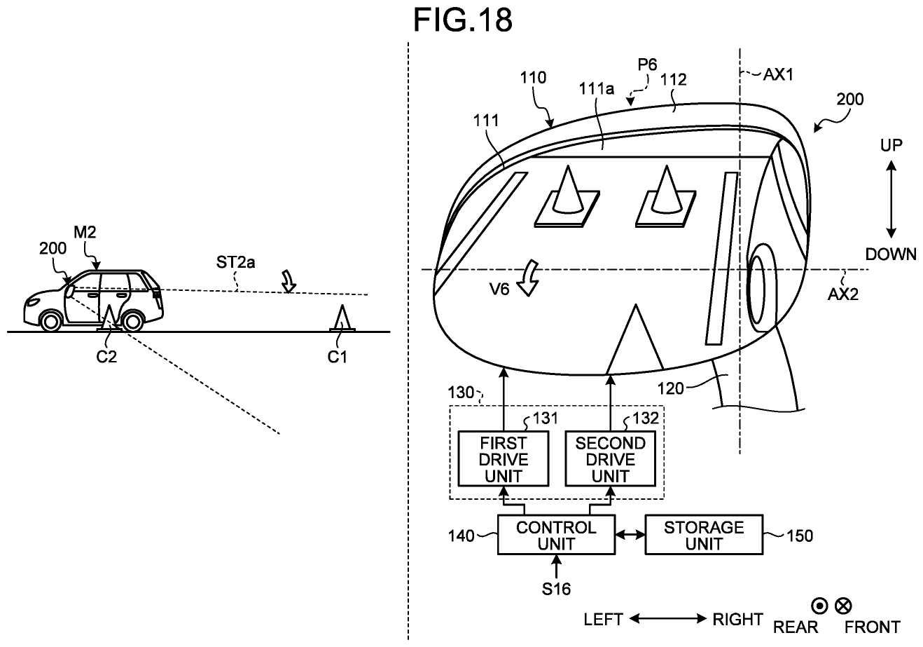

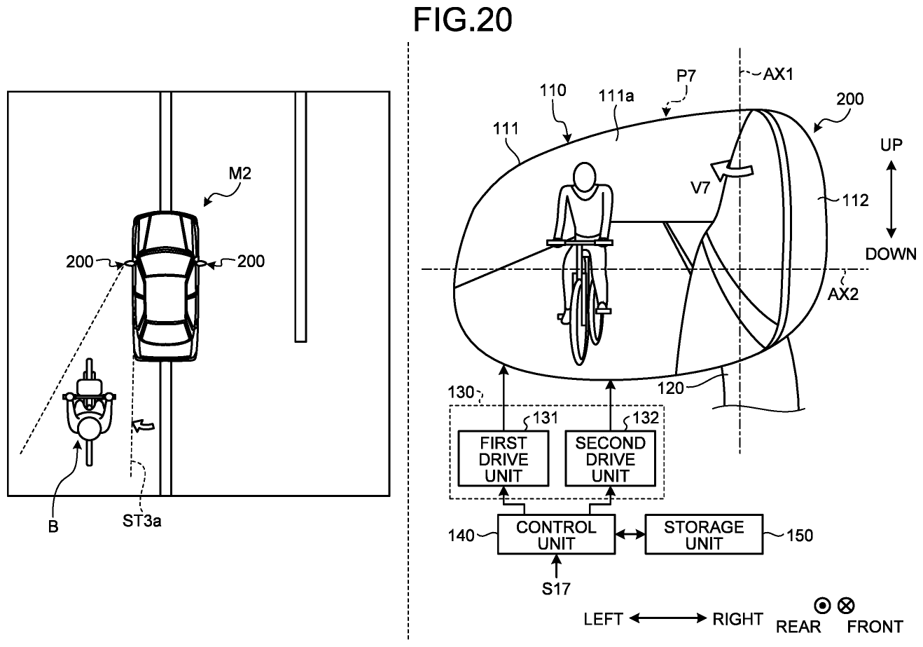

When the main body 110 is rotated in the indicator rotation mode, the control unit 140 controls the drive unit 130 such that the main body 110 is disposed in an indicator operation position P5 (see FIG. 16) stored in the storage unit 150. When the main body 110 is rotated in the shift rotation mode, the control unit 140 controls the drive unit 130 such that the main body 110 is disposed in a reverse position P6 (see FIG. 18) stored in the storage unit 150. When the main body 110 is rotated in the stop/release rotation mode, the control unit 140 controls the drive unit 130 such that the main body 110 is disposed in a stop/release position P7 (see FIG. 20) stored in the storage unit 150.

When the control described above is executed, the control unit 140 may store the rotation position of the main body 110 immediately before execution of each of the indicator rotation mode, the shift rotation mode, and the stop/release rotation mode in the storage unit 150. For example, in the indicator rotation mode, for example, after operation of the direction indicator is finished, the control unit 140 is able to cause the main body 110 to return to the original rotation position stored in the storage unit 150. In addition, for example, in the shift rotation mode, after the shift lever is switched from the reverse position to another position, the control unit 140 is able to cause the main body 110 to return to the original rotation position stored in the storage unit 150. In addition, for example, in the stop/release mode, at the timing after the door on the passenger seat side is opened or the like, the control unit 140 is able to cause the main body 110 to return to the original rotation position stored in the storage unit 150.

The following is an explanation of operations of the vehicle mirror device 200 configured as described above. FIG. 11 to FIG. 14 are diagrams illustrating an example of operations of the vehicle mirror device 200 based on the operation signals.

As illustrated in FIG. 11, in the state in which the main body 110 is disposed in the extended position P2, when the retraction signal S11 is transmitted from the vehicle, the control unit 140 controls the drive unit 130 such that the main body 110 is retracted. In this case, the control unit 140 controls the drive unit 130 on the basis of, for example, information on the retracted position P1 stored in the storage unit 150. Specifically, the control unit 140 controls the drive unit 130 such that the main body 110 is disposed in the retracted position P1. In the first retraction/extension mode, the control unit 140 controls the drive unit 130 such that the main body 110 rotates around the first rotation axis AX1. In the second retraction/extension mode, the control unit 140 controls the drive unit 130 such that the main body 110 rotates around the first rotation axis AX1 and the second rotation axis AX2. In the second retraction/extension mode, when a difference in rotation position between the extended position P2 and the retracted position P1 is 0 for the rotation direction around the second rotation axis AX2, the main body 110 is not required to rotate in the rotation direction around the second rotation axis AX2. When the main body 110 is retracted, the control unit 140 controls the drive unit 130 such that the rotational speed is set to first speed V1. With this control, the main body 110 is disposed in the retracted position P1 from the extended position P2.

As illustrated in FIG. 12, when the extension signal S12 is transmitted from the vehicle in the state in which the main body 110 is disposed in the retracted position P1, the control unit 140 controls the drive unit 130 such that the main body 110 is extended. In this case, the control unit 140 controls the drive unit 130, for example, on the basis of information on the extended position P2 stored in the storage unit 150. Specifically, the control unit 140 controls the drive unit 130 such that the main body 110 is disposed in the extended position P2. In the first retraction/extension mode, the control unit 140 controls the drive unit 130 such that the main body 110 rotates around the first rotation axis AX1. In the second retraction/extension mode, the control unit 140 controls the drive unit 130 such that the main body 110 rotates around the first rotation axis AX1 and the second rotation axis AX2. In the second retraction/extension mode, when a difference in rotation position between the retracted position P1 and the extended position P2 is 0 for the rotation direction around the second rotation axis AX2, the main body 110 is not required to rotate in the rotation direction around the second rotation axis AX2. When the main body 110 is extended, the control unit 140 controls the drive unit 130 such that the rotational speed is set to second speed V2. With this control, the main body 110 is disposed in the extended position P2 from the retracted position P1.

As illustrated in FIG. 13, when the right-left adjustment signal S13 is transmitted from the vehicle in the state in which the main body 110 is disposed in the extended position P2, the control unit 140 controls the drive unit 130 such that the main body 110 rotates on the basis of information on the rotation direction and the rotation amount included in the right-left adjustment signal S13. Specifically, the control unit 140 adjusts the rotation position of the main body 110 in the left-right direction by rotating the main body 110 by a predetermined rotation amount in the rotation direction (either left or right direction) around the first rotation axis AX1. When adjusting the rotation position of the main body 110 in the left-right direction, the control unit 140 controls the drive unit 130 such that the rotational speed is set to third speed V3. With this control, the main body 110 is disposed in the adjustment position P3 acquired by rotating the main body 110 leftward or rightward by a predetermined rotation amount from the extended position P2.

As illustrated in FIG. 14, when the up-down adjustment signal S14 is transmitted from the vehicle in the state in which the main body 110 is disposed in the extended position P2, the control unit 140 controls the drive unit 130 such that the main body 110 rotates on the basis of information on the rotation direction and the rotation amount included in the up-down adjustment signal S14. Specifically, the control unit 140 adjusts the rotation position of the main body 110 in the up-down direction by rotating the main body 110 by a predetermined rotation amount in the rotation direction (either up or down direction) around the second rotation axis AX2. When adjusting the rotation position of the main body 110 in the up-down direction, the control unit 140 controls the drive unit 130 such that the rotational speed is set to fourth speed V4. With this control, the main body 110 is disposed in the adjustment position P4 acquired by rotating the main body 110 upward or downward by a predetermined rotation amount from the extended position P2.

When executing the operations illustrated in FIG. 11 to FIG. 14, the control unit 140 controls the drive unit 130 such that the first speed V1 in retracting the main body 110 and the second speed V2 in extending the main body 110 are higher than the third speed V3 in adjusting the rotation position of the main body 110 in the left-right direction and the fourth speed V4 in adjusting the rotation position of the main body 110 in the up-down direction. The rotation amount in retracting or extending the main body 110 becomes larger than that in adjusting the rotation position of the main body 110. For this reason, the first speed V1 and the second speed V2 in retracting and extending the main body 110 are set higher than the third speed V3 and the fourth speed V4 in adjusting the rotation position. This setting shortens the driver's waiting time. In addition, when adjusting the rotation position of the main body 110, this structure enables adjustment at the rotational speed that is not too fast for the driver or the like performing adjustment.

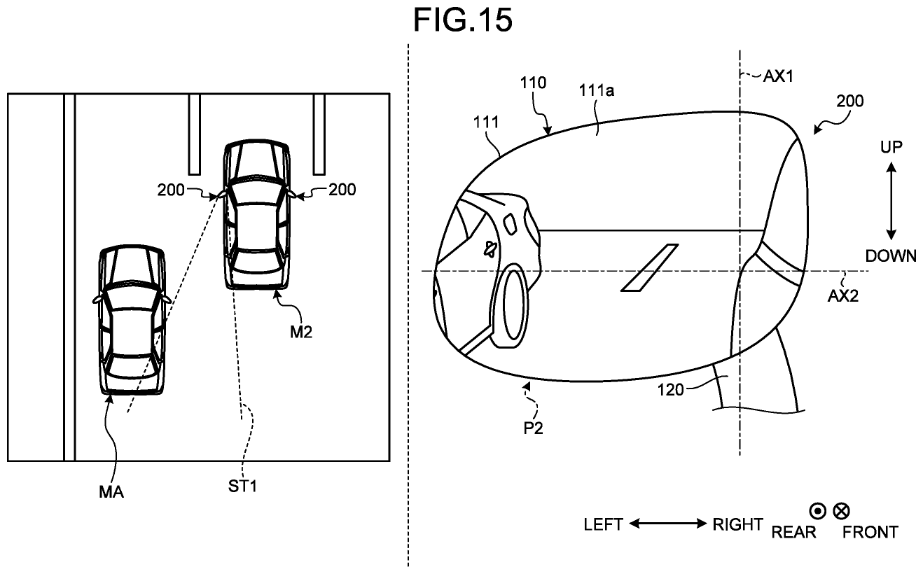

FIG. 15 to FIG. 20 are diagrams illustrating an example of operations of the vehicle mirror device 200 based on signals different from the operation signals. In the examples of FIG. 15 to FIG. 20, the vehicle M2 is explained as the driver's own vehicle. The examples illustrated in FIG. 15 to FIG. 20 illustrate the case where the driver's seat is disposed on the right side in the vehicle M2, as an example.

The left drawing in FIG. 15 illustrates the situation in which the vehicle M2 travels in a certain lane in the state in which the main body 110 is disposed in the extended position P2, and another vehicle MA is traveling in the left lane of the driver's lane and behind the vehicle M2. The left drawing in FIG. 15 also illustrates a visual field ST1 when the driver of the vehicle M2 looks at the vehicle mirror device 200 on the passenger seat side (opposite to the driver's seat). The right drawing in FIG. 15 illustrates an example of an image reflected on the reflection surface 111a when the driver of the vehicle M2 looks at the vehicle mirror device 200 on the passenger seat side (opposite to the driver's seat) from the driver's seat.

In the example illustrated in FIG. 15, when the reflection surface 111a of the vehicle mirror device 200 is viewed from the driver's seat, an image of a rear part of the other vehicle MA is visually recognized. FIG. 16 illustrates an example in the case where the driver of the vehicle M2 operates the direction indicator to set the left direction as the indication direction from the state illustrated in FIG. 15. The direction indication signal S15 is output in response to operation of the direction indicator. The control unit 140 controls the drive unit 130 such that the main body 110 of the vehicle mirror device 200 on the side, of the right and the left sides, corresponding to the indication direction indicated with the direction indication signal S15 rotates outward. In this case, the control unit 140 controls the drive unit 130 such that the main body 110 of the left vehicle mirror device 200 rotates outward (indicator rotation mode). In the indicator rotation mode, the control unit 140 controls the drive unit 130 such that the rotational speed is set to fifth speed V5. With this control, as illustrated in the left drawing in FIG. 16, the main body 110 is disposed to the indicator operation position P5 acquired by rotating the main body 110 leftward by a predetermined rotation amount from the extended position P2. In this manner, a visual field ST1a when the driver of the vehicle M2 looks at the vehicle mirror device 200 on the passenger seat side (side opposite to the driver's seat) from the driver's seat shifts to the outside of the vehicle M2. Thus, as illustrated in the right and left drawings in FIG. 16, the visible range of the vehicle MA is expanded. Specifically, the front part of the vehicle MA can also be visually recognized. Thus, the front range, which is a blind spot when the main body 110 is disposed in the extended position P2, can be visually recognized from the driver's seat.

The left drawing in FIG. 17 illustrates the situation in which the vehicle M2 is going to moving backward by a certain degree in the state in which the main body 110 is disposed in the extended position P2. The left drawing in FIG. 17 illustrates a situation in which two cones C1 are arranged behind the vehicle M2, and a cone C2 is disposed on the left side of the vehicle M2. The left drawing in FIG. 17 also illustrates a visual field ST2 when the driver of the vehicle M2 looks at the vehicle mirror device 200 on the passenger seat side from the driver's seat. The right drawing in FIG. 17 illustrates an example of an image reflected in the reflection surface 111a when the driver of the vehicle M2 looks at the vehicle mirror device 200 on the passenger seat side (opposite to the driver's seat) from the driver's seat. In the example illustrated in FIG. 17, when the reflection surface 111a of the vehicle mirror device 200 is viewed from the driver's seat, an image of the cones C1 in the rear is visually recognized. By contrast, the cone C2 on the left side of the vehicle M2 is in a blind spot and is not visually recognized.

FIG. 18 illustrates an example of the case where the shift lever of the vehicle M2 is operated to be changed to the reverse position from the state illustrated in FIG. 17. The shift lever signal S16 is output in response to operation of the shift lever. The control unit 140 controls the drive unit 130 such that the main body 110 rotates downward. For example, the control unit 140 controls the drive unit 130 such that the main body 110 of the vehicle mirror device 200 disposed on the side, opposite to the driver's seat, of the right and the left sides of the vehicle M2, that is, on the passenger seat side, rotates downward (shift rotation mode). In the shift rotation mode, the control unit 140 controls the drive unit 130 such that the rotational speed is set to sixth speed V6. With this control, as illustrated in the left drawing in FIG. 18, the main body 110 is disposed in the reverse position P6 acquired by rotating the main body 110 downward by a predetermined rotation amount from the extended position P2. In this manner, as illustrated in the left drawing in FIG. 18, a visual field ST2a when the driver of the vehicle M2 looks at the vehicle mirror device 200 on the passenger seat side (side opposite to the driver's seat) from the driver's seat shifts to the lower side of the vehicle M2. With this, the cone C2 on the left side of the vehicle M2 can also be visually recognized. As described above, the lower range, which is a blind spot when the main body 110 is disposed in the extended position P2, can be visually recognize from the driver's seat.

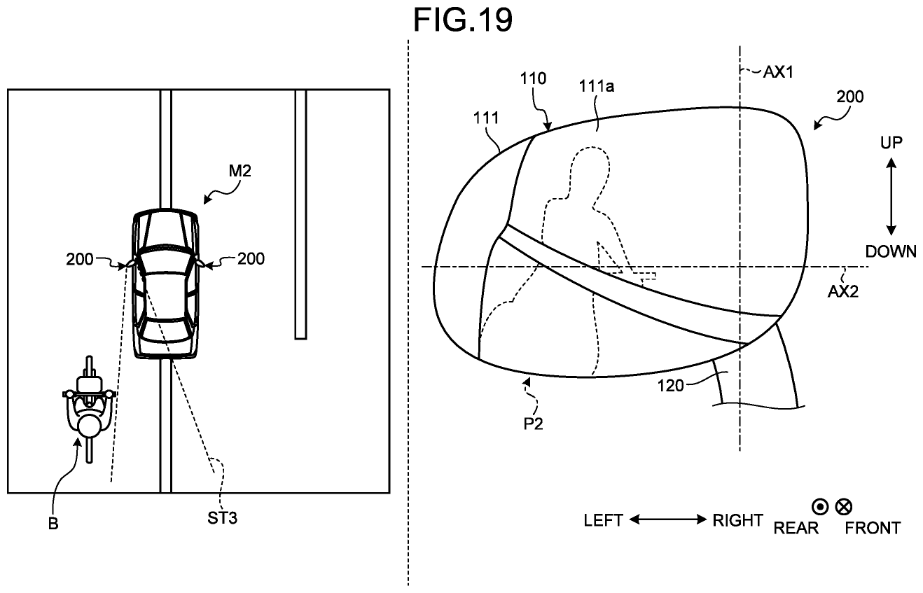

The left drawing in FIG. 19 illustrates a situation in which the vehicle M2 stops in the state in which the main body 110 is disposed in the extended position P2. At this stage, the engine of the vehicle M2 is in an operating state. The left drawing in FIG. 19 also illustrates a visual field ST3 when the fellow passenger of the vehicle M2 looks at the vehicle mirror device 200 on the passenger seat side from the seat opposite to the driver's seat, that is, from the passenger seat. The right drawing in FIG. 15 illustrates an example of an image reflected on the reflection surface 111a when the driver of the vehicle M2 looks at the vehicle mirror device 200 on the passenger seat side (opposite to the driver's seat) from the driver's seat.

In the example illustrated in FIG. 19, when the reflection surface 111a of the vehicle mirror device 200 is viewed from the driver's seat, an image of a rear part of another vehicle MA is visually recognized. By contrast, as described above, the visual field ST3 does not include a bicycle B running in the left rear of the vehicle M2. Accordingly, when the reflection surface 111a of the vehicle mirror device 200 is viewed from the driver's seat, an image of the bicycle B reflected in the body of the vehicle M2 may be visually recognized but the bicycle B cannot be visually recognized directly.

FIG. 20 illustrates an example of the case where the engine of the vehicle M2 stops from the state illustrated in FIG. 19. The getting-off signal S17 is output in response to stoppage of the engine. On the basis of the getting-off signal S17, the control unit 140 controls the drive unit 130 such that the main body 110 on the side opposite to the driver's seat in the right and the left sides of the vehicle M2, that is, on the passenger seat side, rotates toward the outside of the vehicle M2 (stop/release rotation mode). In the stop/release rotation mode, the control unit 140 controls the drive unit 130 such that the rotational speed is set to seventh speed V7. With this control, as illustrated in the left drawing in FIG. 20, the main body 110 is disposed in the stop/release position P7 acquired by rotating the main body 110 leftward by a predetermined rotation amount from the extended position P2. In this manner, a visual field ST3a when the fellow passenger of the vehicle M2 looks at the vehicle mirror device 200 on the passenger seat side (opposite to the driver's seat) from the passenger seat shifts to the outside of the vehicle M2. With this, a bicycle running along the side or in the rear of the vehicle M2 can be directly visually recognized by looking at the vehicle mirror device 200 from the passenger seat side.

The examples illustrated in FIG. 19 and FIG. 20 illustrate the case where the control unit 140 controls the drive unit 130 such that the main body 110 on the passenger seat side rotates toward the outside of the vehicle M2, on the basis of the getting-off signal S17 output when the engine of the vehicle M2 stops, but the structure is not limited thereto. For example, in the state in which the engine of the vehicle M2 stops, the control unit 140 may control the drive unit 130 such that the main body 110 on the passenger seat side rotates toward the outside of the vehicle M2, on the basis of at least one of the unlock signal, the belt release signal, the parking signal, and the passenger detection signal, and the like, in addition to the engine stop signal or instead of the engine stop signal.

When executing the operations illustrated in FIG. 15 to FIG. 20, the control unit 140 controls the drive unit 130 such that each of the fifth speed V5, the sixth speed V6, and the seventh speed V7 rotates at rotational speed higher than the first speed V1 in retracting the main body 110 and the second speed V2 in extending the main body 110. With this control, when the direction indicator is operated, the situation in the sideward range of the vehicle M2 can be promptly checked for the indication direction from the direction indicator. In addition, when the shift lever is switched to the reverse position, the situation in the downward range of the vehicle M2 can be promptly checked. In addition, when the engine of the vehicle M2 stops, the fellow passenger on the passenger seat is able to promptly check the situation in the sideward range on the passenger seat side of the vehicle M2 with the vehicle mirror device 200.

As described above, the vehicle mirror device 200 according to the present embodiment includes the main body 110 including the mirror member 111, the drive unit 130 rotating the main body 110 around the first rotation axis AX1 extending along the up-down direction in the vehicle mounted state and the second rotation axis AX2 extending along the left-right direction in the vehicle mounted state, and the control unit 140 controlling the drive unit 130 such that the main body 110 rotates in the predetermined rotation direction and at the predetermined rotational speed in accordance with a signal that is the signal S10 from the vehicle and different from the operation signal to operate the main body 110.

This structure enables rotation of the main body 110 at the predetermined rotation direction and the predetermined rotational speed in accordance with the type of the signal S10 transmitted from the vehicle and different from the operation signal to operate the main body 110. This structure enables rotation of the main body 110 at the speed in accordance with the situation of the vehicle M2.

In the vehicle mirror device 200 according to the present embodiment, the predetermined rotational speed is rotational speed higher than the rotational speed in adjusting the rotation position of the main body 110 in the extended state. This structure enables adjustment of the rotation position of the main body 110 in a short time.

In the vehicle mirror device 200 according to the present embodiment, the main body 110 is provided on each of the right and the left sides of the vehicle M2, the signal from the vehicle M2 includes the direction indication signal S15 indicating the indication direction from the direction indicator of the vehicle M2, and, when the signal from the vehicle M2 is the direction indication signal S15, the control unit 140 controls the drive unit 130 such that the main body 110 on the side corresponding to the indication direction indicated with the direction indication signal S15 in the right and the left sides of the vehicle M2 rotates toward the outside of the vehicle M2. This structure enables prompt check of the situation in the sideward range of the vehicle M2 for the indication direction from the direction indicator.

In the vehicle mirror device 200 according to the present embodiment, the signal from the vehicle M2 includes the shift lever signal S16 indicating the position of the shift lever of the vehicle M2, and, when the signal from the vehicle M2 is the shift lever signal S16 and the position indicated with the shift lever signal S16 is the reverse position, the control unit 140 controls the drive unit 130 such that the main body 110 rotates downward in the vehicle M2 mounted state. This structure enables prompt check of the situation in the downward range of the vehicle M2 when the shift lever is switched to the reverse position.

In the vehicle mirror device 200 according to the present embodiment, the main body 110 is provided on each of the right and the left sides of the vehicle M2, the signal from the vehicle M2 includes the getting-off signal S17 output when the passenger on the seat on the side, opposite to the driver's seat, of the left-right direction in the vehicle M2 gets off from the vehicle, and, when the signal from the vehicle M2 is the getting-off signal S17, the control unit 140 controls the drive unit 130 such that the main body 110 on the side, opposite to the driver's seat, of the right and the left sides in the vehicle M2 rotates toward the outside of the vehicle M2. This structure enables the fellow passenger on the passenger seat to promptly check the situation in the sideward range of the vehicle M2 on the passenger seat side of the vehicle M2 with the vehicle mirror device 200, when the engine of the vehicle M2 stops.

The vehicle mirror device 200 according to the present embodiment further includes the storage unit 150 storing therein the rotation position of the main body 110, and the control unit 140 controls the drive unit 130 on the basis of the rotation position of the main body 110 stored in the storage unit 150. This structure enables easy control of the rotation position of the main body 110 on the basis of the rotation position stored in the storage unit 150.

The technical range of the present invention is not limited to the embodiments described above, but may be properly changed within a range not departing from the gist of the present invention. For example, the embodiments described above illustrate the cases where the vehicle mirror devices 100 and 200 are door mirrors as an example, but the structure is not limited thereto. The vehicle mirror devices 100 and 200 may be, for example, fender mirrors.

In addition, the embodiments described above illustrate the structure in which the whole main body 110 is exposed to the outside as an example, but the structure is not limited thereto. For example, similar effects as those of the structures of the embodiments described above can be acquired also in the case where the control unit controls the drive unit such that the main body or the housing rotates in a predetermined rotation direction and at predetermined rotational speed in accordance with a signal that is a signal from the vehicle and that is different from the operation signal to operate the main body, in the vehicle mirror device provided with the housing surrounding the front and the rear, the right and the left, and the ahead of the main body 110.

### REFERENCE SIGNS LIST

AX1 FIRST ROTATION AXIS
AX2 SECOND ROTATION AXIS
DL, DR DOOR
M, M2 VEHICLE
P ROTATION POSITION
P1 RETRACTED POSITION
P2 EXTENDED POSITION
P3, P4 ADJUSTMENT POSITION
S, S10 SIGNAL FROM VEHICLE
S1, S11 RETRACTION SIGNAL
S2, S12 EXTENSION SIGNAL
S3, S13 RIGHT-LEFT ADJUSTMENT SIGNAL (ADJUSTMENT SIGNAL)
S4, S14 UP-DOWN ADJUSTMENT SIGNAL (ADJUSTMENT SIGNAL)
S15 DIRECTION INDICATION SIGNAL
S16 SHIFT LEVER SIGNAL
S17 GETTING-OFF SIGNAL
V1 FIRST SPEED
V2 SECOND SPEED
V3 THIRD SPEED
V4 FOURTH SPEED
θ1, θ2 ROTATION ANGLE
10, 110 MAIN BODY
11, 111 MIRROR MEMBER
11a, 111a REFLECTION SURFACE
11b, 111b SURFACE
12, 112 CASE MEMBER
20, 120 VEHICLE CONNECTION PART
30, 130 DRIVE UNIT
31, 131 FIRST DRIVE UNIT
32, 132 SECOND DRIVE UNIT
40, 140 CONTROL UNIT
50, 150 STORAGE UNIT
100, 200 VEHICLE MIRROR DEVICE

1. A vehicle mirror device comprising:
a main body including a mirror member and a case member, the mirror member and the case member being provided to be movable integrally with each other;
a drive unit configured to rotate the main body around a first rotation axis and a second rotation axis, the first rotation axis extending along an up-down direction in a vehicle mounted state, the second rotation axis extending along a left-right direction in the vehicle mounted state; and
a control unit configured to control the drive unit such that the main body rotates in a rotation direction and at rotational speed in accordance with a type of a signal from a vehicle.

2. The vehicle mirror device according to claim 1, wherein
the signal from the vehicle includes
a retraction signal to retract the main body,
an extension signal to extend the main body, and
an adjustment signal to adjust a rotation position of the main body in an extended state, and
when the signal from the vehicle is the retraction signal or the extension signal, the control unit sets the rotational speed of the main body to be higher than rotational speed set when the signal from the vehicle is the adjustment signal.

3. The vehicle mirror device according to claim 1, wherein, when the signal from the vehicle is the retraction signal or the extension signal, the control unit controls the drive unit such that the main body rotates around the first rotation axis.

4. The vehicle mirror device according to claim 3, wherein
the drive unit includes a first drive unit configured to rotate the main body around the first rotation axis and a second drive unit configured to rotate the main body around the second rotation axis, and
the control unit controls the first drive unit when the signal from the vehicle is the retraction signal or the extension signal.

5. The vehicle mirror device according to claim 1, further comprising a storage unit configured to store therein a rotation position of the main body, wherein
the control unit controls the drive unit on the basis of the rotation position of the main body stored in the storage unit.

6. The vehicle mirror device according to claim 5, wherein
the storage unit stores therein the rotation position of the main body in retracting the main body, and
when retracting the main body, the control unit controls the drive unit such that the main body is disposed in the rotation position of the main body stored in the storage unit.

7. The vehicle mirror device according to claim 5, wherein
the storage unit stores therein the rotation position of the main body in extending the main body, and
when extending the main member unit, the control unit controls the drive unit such that the main body is disposed in the rotation position of the main body stored in the storage unit.

8. A vehicle mirror device comprising:
a main body including a mirror member;
a drive unit configured to rotate the main body around a first rotation axis and a second rotation axis, the first rotation axis extending along an up-down direction in a vehicle mounted state, and the second rotation axis extending along a left-right direction in the vehicle mounted state; and
a control unit configured to control the drive unit such that the main body rotates in a predetermined rotation direction and at predetermined rotational speed in accordance with a signal from a vehicle, the signal from the vehicle being different from an operation signal to operate the main body.

9. The vehicle mirror device according to claim 8, wherein the predetermined rotation speed is higher than rotational speed set in adjusting a rotation position of the main body in an extended state.

10. The vehicle mirror device according to claim 9, wherein
the main body is provided on each of right and left sides of the vehicle,
the signal from the vehicle includes a direction indication signal indicating an indication direction of a direction indicator of the vehicle, and
when the signal from the vehicle is the direction indication signal, the control unit controls the drive unit such that the main body on a side, of the right and left sides of the vehicle, corresponding to the indication direction indicated with the direction indication signal rotates toward an outside of the vehicle.

11. The vehicle mirror device according to claim 9, wherein
the signal from the vehicle includes a shift lever signal indicating a position of a shift lever of the vehicle, and
when the signal from the vehicle is the shift lever signal, and the shift lever signal indicates that the position of the shift lever is a reverse position, the control unit controls the drive unit such that the main body rotates downward in a vehicle mounted state.

12. The vehicle mirror device according to claim 9, wherein
the main body is provided on each of right and left sides of the vehicle,
the signal from the vehicle includes a getting-off signal output when a passenger on a seat on a side opposite to a driver's seat in the left-right direction in the vehicle gets off from the vehicle, and
when the signal from the vehicle is the getting-off signal, the control unit controls the drive unit such that the main body on the side opposite to the driver's seat in right and left sides in the vehicle rotates toward an outside of the vehicle.

13. The vehicle mirror device according to claim 8, further comprising a storage unit configured to store therein a rotation position of the main body, wherein
the control unit controls the drive unit on the basis of the rotation position of the main body stored in the storage unit.
